(19) United States
(12) Patent Application Publication
(10) Pub. No.: US 2005/0157234 A1
(43) Pub. Date: Jul. 21, 2005

(54) LCD employing coated compensate film and fabrication method thereof

(75) Inventor: Su Hyun Park, Anyang-si (KR)

Correspondence Address: BRINKS HOFER GILSON & LIONE, P.O. BOX 10395, CHICAGO, IL, 60610, US

(73) Assignee: LG PHILIPS LCD CO., LTD.

(21) Appl. No.: 11/009,295

(22) Filed: Dec. 9, 2004

(30) Foreign Application Priority Data
Dec. 30, 2003 (KR) P2003-100349

(51) Int. Cl. G02F 1/1335

(52) U.S. Cl. 349/117

(57) ABSTRACT

An LCD employing a coated compensate film is provided. The LCD includes a first substrate on which a color filter layer is formed and a second substrate on which a thin film transistor is formed. A liquid crystal layer is interposed between the substrates. Polarizers are attached on outer surfaces of the substrates such that the optical transmission axes of the polarizers are perpendicular to each other. Compensate films are formed by coating a reactive mesogen containing a surfactant on the inner surfaces of the substrates.

This application claims the benefit of Korean Patent Application No. P2003-100349 filed in Korea on Dec. 30, 2003, which is hereby incorporated by reference.

### BACKGROUND

1. Field

The present application relates to a liquid crystal display (LCD), and more particularly, to an LCD employing a coated compensate film and a fabrication method thereof.

2. Description of the Related Art

Generally, liquid crystal molecules have an anisotropy that changes depending on the distribution of the liquid crystal molecules and the distribution of tilt angles of the liquid crystal molecules with respect to the substrate.

The anisotropy of the liquid crystal is an important factor for changing the polarization of light depending on an angle at which a cell or a film including the liquid crystal is viewed. The inherent property of the liquid crystal causes the brightness and contrast ratio to be changed depending on a viewing angle in the upper, the lower, the left, and the right of the LCD. This is one disadvantage of the LCD.

To solve the above disadvantage, a method for attaching a compensate film capable of compensating for anisotropy distribution depending on the viewing angle has been suggested.

The compensate film has, if possible, an opposite anisotropy distribution to the anisotropy distribution of the liquid crystal cell, so that a difference in retardation of light due to a viewing angle is eliminated when the compensate film is incorporated with the cell.

Generally, the compensate film is made of a polymer to change its phase difference with respect to transmitted light and the film is extended in a predetermined direction to have birefringence due to an anisotropy inducement of molecules.

In more detail, for example, when an external electric field is applied to a twisted nematic (TN) liquid crystal display (LCD) of a normally black mode, the liquid crystal molecules are arranged by reacting to the electric field and light transmission is generated by the following formula:
I=Iₒ sin²[θ(1+u²)½], u=πR/θλ, R=Δn·d

Here, I represents the intensity of transmitted light, Iₒ represents the intensity of incident light, Δn represents the birefringence, d represents the thickness of a liquid crystal cell, λ represents the wavelength of transmitted light, θ represents the twist angle of a twisted nematic liquid crystal, and R represents the phase difference.

Here, the phase difference is a value closely related to a viewing angle and it is preferable to compensate for the phase difference so as to improve the viewing angle.

The above-described compensate film is provided between a liquid crystal substrate and a polarizer for a phase difference compensation, and is made of a uniaxial anisotropic material or a biaxial anisotropic material.

FIGS. 1A through 1C are views illustrating refractive index ellipsoids having anisotropy of a phase difference compensate film.

As shown in FIGS. 1A through 1C, whether the compensate film is uniaxial or biaxial is determined by whether or not nx and ny are equal when it is assumed that refractive indices in x-, y-, and z-directions are given by nx, ny, and nz, respectively.

Namely, as shown in FIG. 1A, if the refractive indices in two directions are equal and their sizes are different from each other, the compensate film is said to be uniaxial. Also, as shown in FIGS. 1B and 1C, if the refractive indices in three directions are all different from one another, the compensate film is said to be biaxial.

Generally, a compensate film using an anisotropic material having the uniaxial refractive index is used. Here, a longer axis of the ellipsoid is arranged so as to be in parallel with a surface of the film or vertically arranged with respect to the surface of the film.

In the meantime, the compensate film is fabricated by a method of extending polymer films in a uniaxial direction or biaxial directions, by which an optical axis of a phase difference film may form a predetermined angle with respect to a progressive direction of the film, so that a desired birefringence can be obtained.

However, instead of attaching the compensate film fabricated by the extension method, a method for forming a compensate film by directly coating the compensate film on the substrate has recently been used.

FIG. 2 is a view schematically showing a structure of an LCD using a coated compensated film according to the related art.

As shown in FIG. 2, the LCD using the coated compensate film includes: a first substrate 20 on which a color filter layer 22 is formed; a second substrate 10 on which thin film transistors (TFTs) 12 are formed; a liquid crystal layer 30 interposed between the first and the second substrates 20 and 10 spaced by a predetermined interval from each other; first and second polarizers 21 and 11 respectively attached on outer surfaces of the first and second substrates 20 and 10 such that an optical transmission axis of the first polarizer is perpendicular to that of the second polarizer; a first compensate film 23 coated on an inside of the first substrate 20; a second compensate film 13 coated on the second substrate 10; a first alignment layer 24 formed on the first compensate film 23, for initially aligning liquid crystal molecules contained in the liquid crystal layer 30; and a second alignment layer 14 formed on the second compensate film 13, for initially aligning liquid crystal molecules contained in the liquid crystal layer 30.

The first and the second compensate films 23 and 13 are formed by coating a coatable retarder material in an inside of the substrate.

In more detail, a method for fabricating the first compensate film 23 of the first substrate 20 or the second compensate film 13 of the second substrate 10 is performed in such a way that after an optical alignment layer is formed, an alignment process is performed so that an optical axis of the compensate film may have a predetermined angle afterwards.

Also, an optical curable liquid crystal is coated with a coatable retarder material on the optical alignment layer so that alignment is processed, and subsequently, the coated substrate is fixed into a film by curing nematic crystal molecules using non-polarized ultraviolet (UV) light or an ion-beam.

Also, the alignment layers for aligning liquid crystal molecules are respectively formed on the first and the second substrates formed in this manner.

Since functions of a display device, such as light transmittance, response time, viewing angle and contrast, are determined according to an arrangement characteristics of liquid crystal molecules in the LCD, it is desirable to control an alignment of the liquid crystal molecules in a uniform manner. At this point, since simply interposing the liquid crystal molecules between the first and the second substrates is not enough to uniformly align the liquid crystal molecules, the alignment layer for aligning the liquid crystal molecules is formed on the substrate.

After an organic polymer such as polyimide or polyamide, as the alignment material is printed on the substrate and then cured. A rubbing method, or an ion-beam or optical alignment method is applied. In the case of the rubbing method, the cured alignment layer is rubbed in a predetermined direction with a rubbing sheet of a particular shape so that a groove of a predetermined direction is formed on a surface of the alignment layer.

FIG. 3 is a view showing an alignment status of a coatable retarder according to the related art.

As shown in FIG. 3, an optically curable liquid crystal, which is a coatable retarder material, is coated on the optical alignment layer on which alignment is processed, so that a retarder is formed.

At this point, a lower layer of the coatable retarder material coated on the optical alignment layer can be aligned by the optical alignment layer. However, the coatable retarder liquid crystal molecules tend to vertically rise at a portion contacting with an air layer on the surface toward the upper layer.

A wetting degree of the coatable retarder material is determined by the interface and a surface tension of the coatable retarder material. Generally, since the surface tension of the material is large, the amount of wetting is limited on the interface and thus a poor coating is obtained.

It is also difficult to align the coatable retarder liquid crystal molecules contained in the portion contacting the air layer, resulting in defects in alignment of the coatable retarder liquid crystal molecules.

### SUMMARY

Aspects detailed below include an LCD employing a coated compensate film and a manufacturing method thereof, in which processes of forming an alignment layer can be reduced using materials having both functions of a compensate film and an alignment layer.

An LCD employing a coated compensate film, and a manufacturing method thereof, is detailed below that has an improved alignment performance. In such an LCD, when a compensate film is formed by coating a coatable retarder using a liquid crystal, a surface tension of the coatable retarder solution is lowered by adding a surfactant. In this manner, the alignment of the liquid crystal on the coated upper layer is adjusted.

Additional features will be set forth in part in the description which follows and in part will become apparent to those having ordinary skill in the art upon examination of the following or may be learned from practice of the application.

By way of introduction only, in one aspect, an LCD using a coated compensate film includes opposing substrates having a liquid crystal layer interposed therebetween. Polarizers are attached on outer surfaces of the substrates. A compensate film containing a reactive mesogen and a surfactant is coated on an inner surface of at least one of the substrates.

In another aspect, a method for fabricating an LCD using a coated compensate film includes depositing and aligning an optical alignment layer on a substrate, coating a mixture that includes a reactive mesogen and a surfactant on the optical alignment layer, and aligning the mixture.

It is to be understood that both the foregoing general description and the following detailed description in the application are exemplary and explanatory and are intended to provide further explanation of the invention as claimed.

### BRIEF DESCRIPTION OF THE DRAWINGS

The accompanying drawings, which are included to provide a further understanding of the application and are incorporated in and constitute a part of this application, illustrate embodiment(s) and together with the description serve to explain the principles of the embodiments. In the drawings:

FIGS. 1A through 1C are views showing an elliptic body having an anisotropy birefringence of a phase difference compensate film;

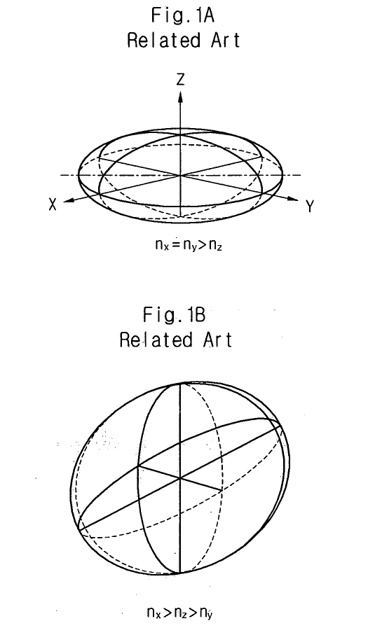

FIG. 2 is a view schematically showing a structure of an LCD using a coated compensate film of the related art;

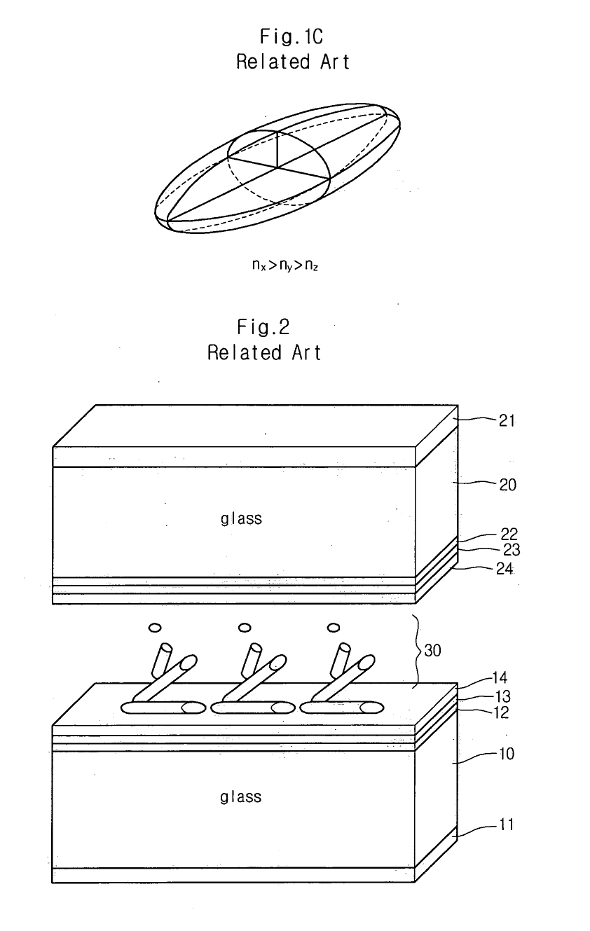

FIG. 3 is a view showing an alignment status of a coatable retarder according to the related art;

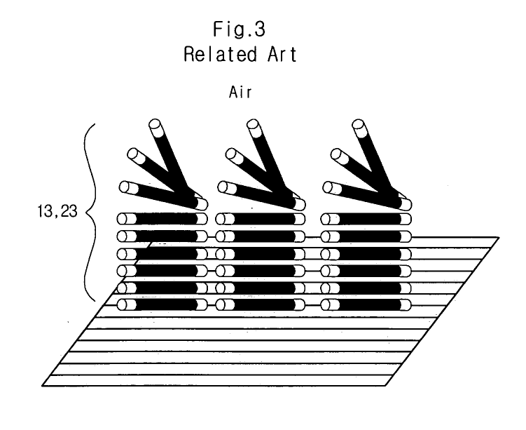

FIG. 4 is a view schematically showing a structure of an LCD using a coated compensate film according to an aspect of the present invention; and

FIGS. 5A through 5D are views explaining a method for fabricating an LCD using a coated compensate film according to an aspect of the present invention;

FIG. 6 is a view showing an alignment characteristics of a reactive mesogen material containing a surfactant according to an aspect of the present invention;

FIG. 7 is a view showing an element of the general surfactant; and

FIG. 8 is a view showing an alignment status of a coatable retarder of FIG. 6.

### DETAILED DESCRIPTION

Reference will now be made in detail to different embodiments, examples of which are illustrated in the accompanying drawings.

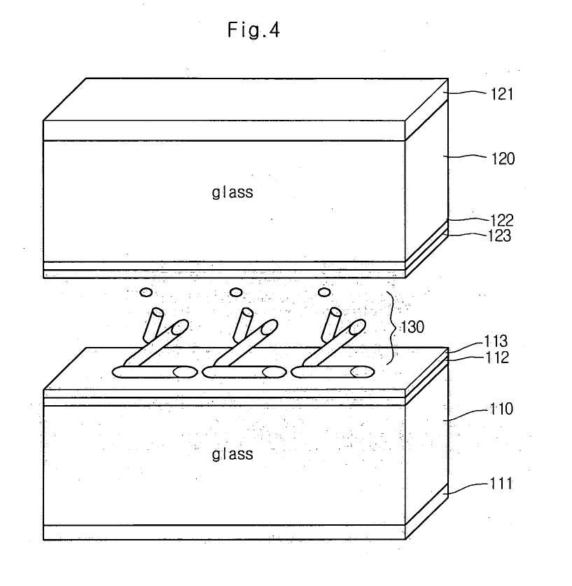

FIG. 4 shows one structure of an LCD using a coated compensate film.

Referring to FIG. 4, an LCD using a coated compensate film includes: a first substrate 120 on which a color filter layer 122 is formed; a second substrate 110 on which a TFT 112 is formed; a liquid crystal layer 130 interposed between the first and the second substrates 120 and 110 spaced apart from each other by a predetermined interval; first and second polarizers 121 and 111 respectively attached on outer surfaces of the first and second substrates 120 and 110 such that an optical transmission axis of the first polarizer is perpendicular to that of the second polarizer; a first compensate film 123 formed by coating a reactive mesogen containing a surfactant on an inner surface of the first substrate 120; and a second compensate film 113 formed by coating the reactive mesogen on an inner surface of the second substrate 110.

Though not shown in the second substrate 110, a TFT acting as a switching element and a pixel electrode are formed on an intersection between a gate bus line and a data bus line.

A black matrix (BM) layer, a color filter layer and a common electrode are sequentially formed on the first substrate 120. Here, an overcoat layer may be additionally formed between the color filter layer and the common electrode on the first substrate 120.

Also, the first and second polarizers 121 and 111 for changing ambient light into linearly polarized light by transmitting light in parallel with an optical transmission axis only are further arranged on outer surfaces of the first and the second substrates 120 and 110, i.e., an upper surface of the first substrate 120 and a lower surface of the second substrate 110, respectively. Here, the light transmission axis of the first polarizer 121 is perpendicular to the light transmission axis of the second polarizer 111.

The first and the second compensate films 123 and 113 are formed by a reactive mesogen containing a surfactant. The first and the second compensate films 123 and 113 thus minimize the differences in light retardation across the LCD and simultaneously act as an alignment layer.

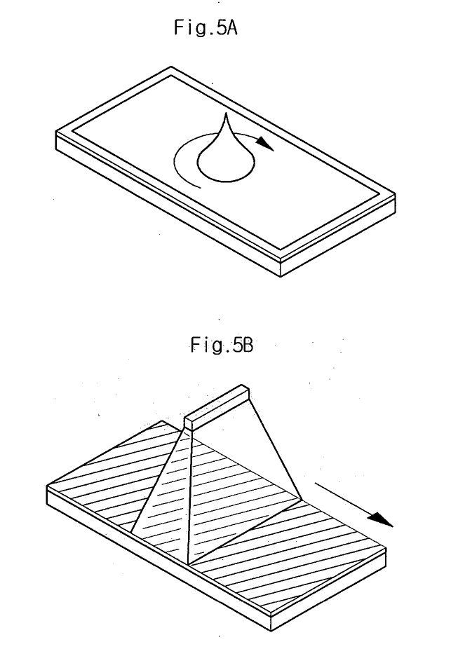

FIGS. 5A through 5D are views explaining a method for fabricating an LCD using a coated compensate film.

Referring to FIG. 5A, a high molecular material called an optical alignment layer is deposited so as to align liquid crystal molecules in a specific direction on the first substrate 120 on which a color filter layer is formed and the second substrate 110 on which a TFT is formed. After a solvent is evaporated at temperatures of 60-80° C., the optical alignment layer is aligned and cured at temperatures of 80-200° C. Here, a polyimide-based organic material may be used as the optical alignment layer.

Referring to FIG. 5B, an alignment process is performed by applying non-polarized UV light or an ion-beam to the optical alignment layer. Particularly, it is possible to get an optical axis of the compensate film to form a predetermined angle with respect to a progression direction of the film by arbitrarily adjusting the alignment direction of the optical alignment layer. Alternatively, rubbing may be used to align the optical alignment layer.

Next, referring to FIG. 5C, a reactive mesogen, to which a surfactant for forming a coatable retarder is added, is coated on the optical alignment layer. A material containing dimethylsiloxane as its primary ingredient may be used for the surfactant. An amount of the surfactant that corresponds to about 0.01 to about 10% of the coatable retarder is added to the reactive mesogen. Since the reactive mesogen forming the coatable retarder has liquid crystal properties as well as progressing straight, the reactive mesogen is apt to be aligned in one direction.

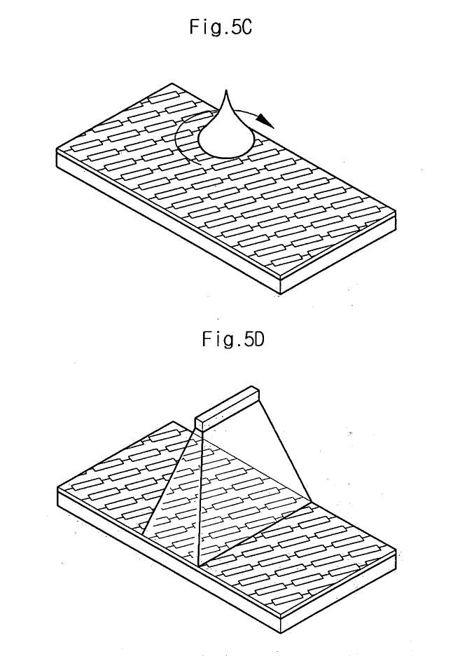

FIG. 6 is a view showing an alignment characteristic of a reactive mesogen containing a surfactant.

Referring to FIG. 6, the surfactant 514 has both a hydrophobic radical 515a and a hydrophilic radical 515b within one molecule. The hydrophobic radical prefers to contact air, and the hydrophilic radical positioned on the other side of the hydrophobic radical prefers to contact the liquid crystal layer. The surfactant 514 plays a role in lowering the surface tension together with acting as a leveling agent 513 for planarization of the surface. The original surface is shown as a choppy solid line and the leveling effect of the mixture containing the surfactant 514 is shown as a dashed line.

In more detail, if liquid crystal molecules 512 in which a surfactant 514 having the above-described properties is mixed are deposited on a substrate 510 on which an optical alignment layer 511 is formed, the hydrophobic radical of the additive (i.e., the surfactant) is positioned at an interface between the liquid crystal molecules and the air layer so as to increase contact with the air layer.

The hydrophilic radical 515b alleviates the tendency of the liquid crystal molecules to contact air and be arranged vertically on the surface by interacting with the liquid crystal molecules 512. Therefore, an alignment direction of the liquid crystal molecule 512, i.e., an inclination degree is controlled.

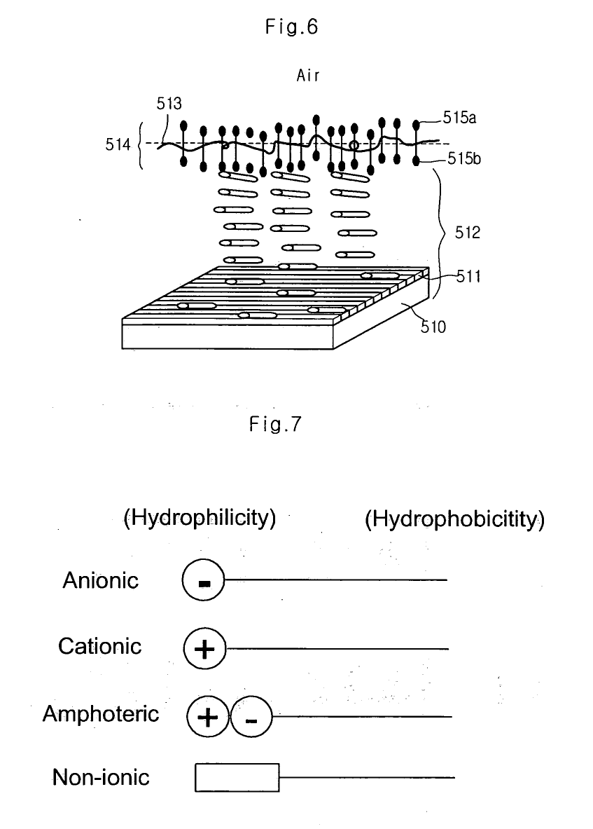

FIG. 7 is a view showing an element of the general surfactant.

Referring to FIG. 7, if a small amount of the surfactant is added to a solvent and coated, the surfactant is absorbed, introduces physical-chemical or chemical properties to the mixture, and plays a role in lowering surface tension of the mixture, which improves coating performance by increasing wetting of the mixture. Also, it is possible to eliminate strain (spin pattern) generated upon spin-coating due to an increase of wettability of the mixture.

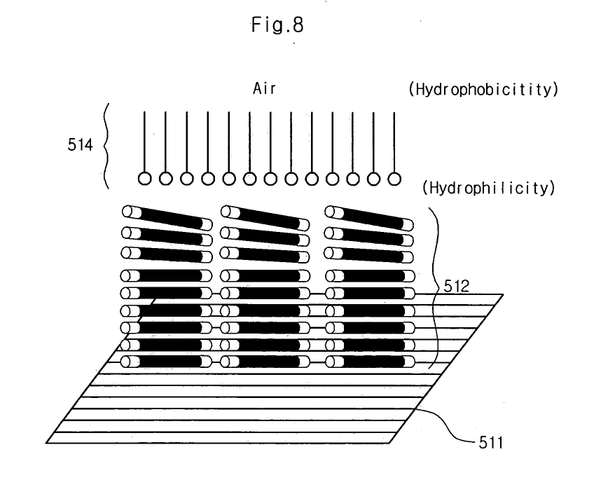

FIG. 8 is a view showing alignment status of a coatable retarder of FIG. 6.

Referring to FIG. 8, the liquid crystal molecules 512 of the coatable retarder contained in a part facing air through the surfactant 514 are not configured vertically but controlled to have an arbitrary slope in a desired direction, which can contribute to displaying the maximum efficiency as a viewing angle compensate film of the LCD panel. That is, as the surfactant 514 has both the hydrophobic radical and the hydrophilic radical, the surfactant 514 generally exists on an interface between polarized and non-polarized materials. The hydrophobic radical faces the non-polarized material and the hydrophilic radical faces the polarized material. Therefore, the liquid crystal molecules of the coatable retarder are not vertically erect, so that the alignment problems can be solved.

It is possible to fabricate various kinds of compensate films for cholesteric, smectic liquid crystals as well as nematic liquid crystals by controlling a slope between the uppermost liquid crystal molecule and the liquid crystal molecule facing the lower substrate, depending on the kind of the surfactant and the type of substrate.

Referring to FIG. 5D, after the substrate on which the reactive mesogen containing the surfactant is coated is fixed into a film by curing the reactive mesogen using non-polarized UV light or an ion-beam, polarized UV light is applied to the film to align the layer.

In more detail, if a light illumination apparatus for applying the polarized UV light generates non-polarized UV light, the non-polarized UV light is transmitted through a polarizer (not shown) of the light illumination apparatus, so that polarized UV light is applied to the coated liquid crystal.

Here, regarding an illumination direction and angle of the polarized UV light applied the liquid crystal, the alignment of the liquid crystal is determined depending on a calculated value of a birefringence of the liquid crystal molecules.

If directions of the liquid crystal molecules are all the same as the alignment direction of the optical alignment layer, distributions of the indices of refraction of the film and of the liquid crystal molecule would be the same.

Therefore, if the index of the birefringence for the liquid crystal molecule is A n=0.133, the index of the birefringence for the fabricated film is measured to be almost the same value Δn=0.133 as that of the liquid crystal molecule.

Also, a retardation value of the liquid crystal film changes depending on a thickness of the coating. If the coating has a thickness of 0.8˜1.5 μm, a film having a phase difference λ/4 (in a visual range) is fabricated. Therefore, the retardation of the phase difference film where a coating thickness of the nematic liquid crystal has been controlled, has a range of 50˜400 nm.

The coatable retarder of the cured reactive mesogen can be alignment-processed by rubbing or using ion-beam alignment, optical alignment or plasma alignment instead of using the polarized UV light. Therefore, by performing an alignment process on the coatable retarder layer after forming the coatable retarder layer using the reactive mesogen, the compensate film acts like an alignment layer for aligning the liquid crystal molecules contained in the liquid crystal layer as well as acting like a compensate film.

Also, it is possible to improve the alignment performance by adding a surfactant to the reactive mesogen so as to lower the surface tension of the coated coatable retarder, and controlling alignment of the liquid crystal molecules contained in an upper layer.

As described above, the LCD employing the coated compensate film can improve alignment performance by adding a surfactant to lower the surface tension of the coatable retarder solvent, and controlling alignment of the liquid crystal molecules contained in the upper layer.

It will be apparent to those skilled in the art that various modifications and variations can be made. Thus, it is intended that the present invention covers the modifications and variations of this invention provided they come within the scope of the appended claims and their equivalents.

1. An LCD comprising:
opposing substrates;
a liquid crystal layer interposed between the substrates;
polarizers attached on outer surfaces of the substrates; and
a coated compensate film on an inner surface of at least one of the substrates, the compensate film containing a reactive mesogen and a surfactant.

2. The LCD according to claim 1, wherein the surfactant has both a hydrophobic radical and a hydrophilic radical within one molecule, the hydrophobic radical preferring to contact air, the hydrophilic radical positioned on an opposing side of the hydrophobic radical and preferring to contact the liquid crystal layer.

3. The LCD according to claim 1, wherein the surfactant has dimethylsiloxane as a main ingredient.

4. The LCD according to claim 1, wherein at least one of the compensate films contains about 0.01 to about 10% surfactant.

5. The LCD according to claim 1, wherein the liquid crystal molecules are aligned by the compensate films.

6. The LCD according to claim 1, wherein the reactive mesogen comprises a liquid crystal material aligned in one direction.

7. The LCD according to claim 1, wherein the reactive mesogen comprises a uniaxial or biaxial liquid crystal material containing a curable radical.

8. The LCD according to claim 1, wherein the reactive mesogen comprises nematic liquid crystals.

9. The LCD according to claim 1, wherein the reactive mesogen is aligned by rubbing, ion-beam alignment, optical alignment, or plasma alignment.

10. The LCD according to claim 1, wherein the liquid crystal layer contacts the compensate films.

11. The LCD according to claim 1, wherein coated compensate films are formed on each substrate.

12. An LCD comprising:
opposing substrates;
a liquid crystal layer interposed between the substrates;
polarizers attached on outer surfaces of the substrates; and
means for simultaneously aligning and compensating for anisotropic distribution of liquid crystal molecules in the liquid crystal layer.

13. A method for fabricating an LCD using a coated compensate film, the method comprising:
depositing an optical alignment layer on a substrate of the LCD;
aligning the optical alignment layer;
coating a mixture on the optical alignment layer, the mixture containing a reactive mesogen and a surfactant; and
aligning the coated mixture.

14. The method according to claim 13, wherein the surfactant has both a hydrophobic radical and a hydrophilic radical within one molecule, the hydrophobic radical preferring to contact air, the hydrophilic radical positioned on an opposing side of the hydrophobic radical and preferring to contact the liquid crystal layer.

15. The method according to claim 13, wherein the surfactant has dimethylsiloxane as a main ingredient.

16. The method according to claim 13, wherein the reactive mesogen contains about 0.01 to about 10% surfactant.

17. The method according to claim 13, wherein the reactive mesogen is a liquid crystal material that is aligned in one direction.

18. The method according to claim 13, wherein the reactive mesogen contains a uniaxial or biaxial liquid crystal material having a curable radical.

19. The method according to claim 13, wherein the reactive mesogen contains a nematic liquid crystal.

20. The method according to claim 13, further comprising aligning the mixture by rubbing, ion-beam alignment, optical alignment, or plasma alignment.

21. The method according to claim 13, wherein the optical alignment layer deposited on the substrate contains a solvent, the method further comprising evaporating the solvent at temperatures of about 60-80° C. and curing the optical alignment layer at temperatures of about 80-200° C.

22. The method according to claim 13, wherein the optical alignment layer contains a polyimide-based organic material.

23. The method according to claim 13, further comprising depositing the optical alignment layer on the substrate by printing.

24. The method according to claim 13, further comprising curing the mixture before aligned the mixture.

25. A method for fabricating an LCD comprising:
providing opposing substrates and a liquid crystal layer between the substrates;
depositing an optical alignment layer on at least one of substrates;
aligning the optical alignment layer; and
providing a single layer on the optical alignment layer, the single layer simultaneously aligning and compensating for anisotropic distribution of liquid crystal molecules in the liquid crystal layer.

26. The method according to claim 25, wherein the single layer comprises a plurality of components.

27. The method according to claim 26, wherein one of the components lowers a surface tension of the single layer and planarizes a surface of the single layer.

28. The method according to claim 26, wherein one of the components provides a buffer layer between another of the components and the liquid crystal layer.

29. The method according to claim 25, wherein the single layer contacts the liquid crystal layer.
